(19) United States
(12) Patent Application Publication
(10) Pub. No.: US 2023/0229468 A1
(43) Pub. Date: Jul. 20, 2023

(54) PRE-POPULATED SECURITY POLICIES FOR VIRTUAL DESKTOP SESSIONS

(71) Applicant: VMWARE, INC., Palo Alto, CA (US)

(72) Inventors: SHIRISH VIJAYVARGIYA, Pune (IN); BIDESH CHITNIS, Pune (IN)

(21) Appl. No.: 17/696,921

(22) Filed: Mar. 17, 2022

(30) Foreign Application Priority Data
Jan. 15, 2022 (IN) 202241002422

(51) Int. Cl. G06F 9/455

(52) U.S. Cl. CPC G06F 9/45545; G06F 9/45558; G06F 2009/45583; G06F 2009/45579

(57) ABSTRACT

In an example, a management node includes a processor and a memory communicatively coupled to the processor. The memory may include an advisory module to receive data related to a login pattern of a user over a period of time and predict a time to launch a virtual desktop session for the user based on the received data. Further, the advisory module may fetch, via a network, a security policy from a cloud-based endpoint protection platform prior to the predicted time. Furthermore, the advisory module may populate a virtual machine with the security policy before the user logs into the virtual desktop session. Then, the advisory module may create the virtual desktop session using the virtual machine populated with the security policy in response to a determination that the user logged into the virtual desktop session prior to an expiration of a timer.

### RELATED APPLICATION

Benefit is claimed under 35 U.S.C. 119(a)-(d) to Foreign Application Serial No. 202241002422 filed in India entitled “PRE-POPULATED SECURITY POLICIES FOR VIRTUAL DESKTOP SESSIONS”, on Jan. 15, 2022, by VMware, Inc., which is herein incorporated in its entirety by reference for all purposes.

### TECHNICAL FIELD

The present disclosure relates to computing environments, and more particularly to methods, techniques, and systems for pre-populating security policies for virtual desktop sessions in a cloud computing infrastructure.

### BACKGROUND

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a VDI or DAAS environment, each user in an enterprise may be provisioned a virtual desktop and is allowed to access the provisioned virtual desktop over a remote network connection, such as a wide area network (WAN) connection. The virtual desktops are hosted on servers that reside in a data center of the enterprise (or a third-party service provider), and each host server may execute multiple virtual desktops. Users can utilize a client device to remotely log into their individual virtual desktop and all of the application execution takes place on the remote host server which is linked to the local client device over a network using a remote display protocol, such as remote desktop protocol (RDP), PC-over-IP protocol (PCoIP), virtual network computing (VNC) protocol, or the like. Using the remote desktop protocol, the user can interact with applications of the virtual desktop, which are running on the remote host server, with only the display, keyboard, and mouse information communicated with the client device.

### BRIEF DESCRIPTION OF THE DRAWINGS

FIG. 1 is a block diagram of an example system, depicting a management node to provide a pre-populated virtual desktop session;

FIG. 2 is a sequence diagram illustrating a sequence of events to populate a virtual machine with a security policy based on a pre-launch time;

FIG. 3 is a flow diagram, illustrating an example computer-implemented method for providing a virtual desktop session; and

FIG. 4 is a block diagram of an example management node including non-transitory computer-readable storage medium storing instructions to create a virtual desktop session using a virtual machine populated with a security policy.

The drawings described herein are for illustration purposes and are not intended to limit the scope of the present subject matter in any way.

### DETAILED DESCRIPTION

Examples described herein may provide an enhanced computer-based and/or network-based method, technique, and system to pre-populate security policies for virtual desktop sessions in a computing environment. The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications.

In such a virtualized environment, virtual desktops may be provided as part of a virtual desktop infrastructure (VDI) or desktop-as-a-service (DAAS) offerings. A virtual desktop is executed on a virtual machine managed by a hypervisor executed on a server in the data center. In this example, the virtual desktop is an interface available to an individual user in the virtualized environment. Further, an experience of using desktop virtualization may be interpreted by users based on a responsiveness of the virtual desktop. In some examples, the responsiveness of the virtual desktop may be affected by multiple factors such as logon time, retrieving and configuring the virtual machine with security policies, session response time, and the like.

For example, in the VDI, the virtual machines are associated with a pool in designated servers and consumed on a per-need basis. When a user attempts to get a session with his virtual desktop, a virtual machine may be retrieved from the pool of available virtual machines and customized for that user by adding the necessary applications, files, and user data to that virtual machine. Once the user stops using the virtual machine, the virtual machine goes back into the pool and becomes available to other users.

To harden the virtual machines and to reduce attack surface (i.e., a sum of all possible security risk exposures where an unauthorized user can try to enter data to or extract data from the virtual machines), the users/security administrators create the security rules and policies as follows:
rapid configuration rules (e.g., out-of-the-box and cloud-native protection rules to simplify configuration of application control policies and optimize protection against attacks targeting servers),
an application approved list (e.g., application control policies to allow running of selected applications or files),
a hash banning list or an application unapproved list (e.g., application control policies to deny execution of certain applications or files), and
a user specific access control list and a network policy.

Further, to enable out of box security, the above-mentioned security rules and policies have to be pulled from a cloud-based endpoint protection platform (e.g., a carbon black cloud (CBC) infrastructure) for a user at the time when the user logs into the virtual machine. This process can take a significant amount of time and places a strain on the cloud-based endpoint protection platform. For example, during a login storm, when multiple users attempt to log into their virtual desktops, policies for all users may have to be fetched from the cloud-based endpoint protection platform and may end up in an unacceptable delay in the security decision. Such delays may eventually affect cloud-based endpoint protection platform scalability, stability, and efficacy. Also, whenever a new virtual session is launched, the above-mentioned tasks, such as retrieving security rules and policies from a cloud service, are performed for launching the virtual desktop or applications. These tasks may lead to latency of the actual desktop and session launch and therefore gives a negative impact on the overall end user experience.

Examples described herein provides a management node for pre-populating security policies for a virtual desktop session before a user logs into the virtual desktop session. During operation, the management node may receive data related to a login pattern of a user over a period of time. Further, the management node may predict a time to launch a virtual desktop session for the user based on the received data. Prior to the predicted time, the management node may assign a virtual machine from a pool of available virtual machines to the user, fetch a security policy from a cloud-based endpoint protection platform via a network, and populate the virtual machine with the security policy. Furthermore, the management node may create the virtual desktop session using the virtual machine populated with the security policy in response to a determination that the user logged into the virtual desktop session prior to an expiration of a timer. Also, the management node may discard the fetched security policy from the virtual machine in response to a determination that the timer expires without the user logged into the virtual desktop session. Upon discarding the fetched security policy from the virtual machine, the management node may place the virtual machine back in the pool of available virtual machines.

Thus, examples described herein pro-actively populate rapid configurations, security rules, and user customized policies in advance of user login, thereby effectively distributing the load on the VDI resources over a wider time interval. Since the virtual desktop session is created before a user logs into the virtual desktop session, the created virtual session may be provided to the user instantly without any delay when the user logs into the virtual desktop session.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

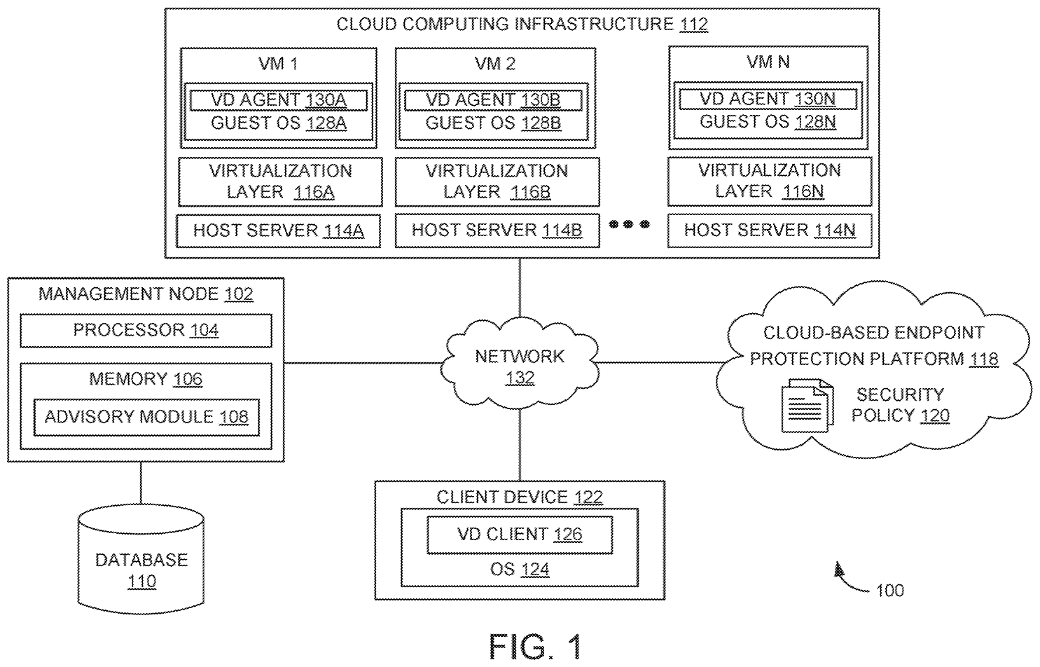

FIG. 1 is a block diagram of an example system 100, depicting a management node 102 to pre-populate security policies for a virtual desktop session. Example system 100 represents a virtual desktop environment. The virtual desktop environment, such as a virtual desktop infrastructure (VDI) or desktop-as-a-service (DAAS) environment, includes a cloud computing infrastructure 112 having multiple host servers 114A-114N. For example, host servers 114A-114N physically reside in a data center of an enterprise (e.g., in case of VDI) or in a data center of a third-party service provider (e.g., in case of DAAS). Further, each of host servers 114A-114N may be a physical computer including an operating system (OS). Furthermore, host servers 114A-114N may include respective virtualization layers 116A-116N that support execution of one or more virtual machines (e.g., VM 1 to VM N). Example virtualization layer (e.g., 116A-116N) may be a hypervisor, a virtual machine manager (VMM), or other software that allows multiple virtual machines to share the physical resources of respective host servers 114A-114N. In some examples, each virtual machine (e.g., VM 1 to VM N) can execute a guest operating system (e.g., 128A-128N) that hosts a virtual desktop (VD) agent (e.g., 130A-130N) for a user at a time.

Further, system 100 may include management node 102 communicatively connected to cloud computing infrastructure 112 to manage different objects/resources in cloud computing infrastructure 112. Management node 102 may refer to a computing device, or computer program (i.e., executing on a computing device), that provides services to host servers 114A-114N. For example, management node 102 may execute centralized management services that may be interconnected to manage the resources centrally in cloud computing infrastructure 112. In an example, a resource may be a server resource, a storage resource, a network resource, a virtual resource, or the like in cloud computing infrastructure 112. For example, the resource may include components in cloud computing infrastructure 112 such as host servers 114A-114N, virtual machines VM 1-VM N, and the like. In some examples, cloud computing infrastructure 112 may be managed by one or more administrators via management node 102.

Furthermore, system 100 includes a cloud-based endpoint protection platform 118 (e.g., VMware Carbon Black Cloud). VMware Carbon Black Cloud is a software as a service (SaaS) solution that provides next-generation anti-virus (NGAV), endpoint detection and response (EDR), advanced threat hunting, and vulnerability management within a single console using a single, lightweight agent. Example cloud-based endpoint protection platform 118 may include a security policy 120 to lock down endpoints and critical systems, prevent unwanted changes, ensure continuous compliance with regulatory mandates, and the like. In an example, cloud-based endpoint protection platform 118 may be communicatively coupled to management node 102 to provide security policy 120 to provide protection to resources in cloud computing infrastructure 112.

As shown in FIG. 1, management node 102, cloud computing infrastructure 112, and cloud-based endpoint protection platform 118 may be communicatively coupled via a network 132. Example network 132 can be a managed Internet protocol (IP) network administered by a service provider. For example, network 132 may be implemented using wireless protocols and technologies, such as Wi-Fi, WiMax, and the like. In other examples, network 132 can also be a packet-switched network such as a local area network, wide area network, metropolitan area network, Internet network, or other similar type of network environment. In yet other examples, network 132 may be a fixed wireless network, a wireless local area network (LAN), a wireless wide area network (WAN), a personal area network (PAN), a virtual private network (VPN), intranet or other suitable network system and includes equipment for receiving and transmitting signals. In other examples, the functions of management node 102 can be implemented as a part of cloud computing infrastructure 112 or cloud-based endpoint protection platform 118.

In some examples, a host server (e.g., 114A-114N) can interoperate with a client device 122 to provide virtual desktop (VD) services to the user of client device 122. Client device 122 may be a computing device (e.g., a thin client, a mobile device, or the like) including an operating system 124 to execute different applications on client device 122. Further, client device 122 can execute an operating system (OS) 124 that hosts a virtual desktop (VD) client 126. Virtual desktop client 126 can be a stand-alone, designated client application (“native client”), or a web browser (“web client”). In some cases, a standard web browser may be modified with a plugin to operate as a web client. The interaction between the virtual desktop and client device 122 can be facilitated by virtual desktop client 126 running in operating system 124 which communicates with host server's (e.g., 114A-14N) side virtual desktop agent (e.g., 130A-130N) that is running on guest operating system (e.g., 128A-128N). For example, the interaction can be performed by virtual desktop agent 130A transmitting encoded visual display information (e.g., framebuffer data) over network 132 to virtual desktop client 126 and virtual desktop client 126 in turn transmitting user input events (e.g., keyboard, mouse events, and the like) to remote desktop agent 130A. In this context, the terms “desktop”, “remote desktop”, and “virtual desktop” refer to a computing environment in which the user can launch, interact with, and manage the user's applications, settings, and data. Further, client device 122 can allow the user to view on a desktop graphical user interface (on a local display device) his/her desktop that is running remotely on host server (e.g., one of 114A-114N), as well as provide commands for controlling the desktop. In this manner, the user of client device 122 can interact with the desktops hosted on host server (e.g., 114A-114N) as if the desktops were executing locally on client device 122.

As shown in FIG. 1, management node 102 includes a processor 104 and a memory 106 coupled to processor 104. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein.

As shown in FIG. 1, memory 106 includes an advisory module 108. During operation, advisory module 108 may receive data related to a login pattern of a user over a period of time. In an example, advisory module 108 may receive the data from a database 110, which is accessible to management node 102. Database 110 may store the data related to the login pattern of users over the period of time. The login pattern may include access history of the user for login and launching the virtual desktop session. The login patterns of the user may be monitored for the pre-defined time duration to predict the login pattern of the user.

Further, advisory module 108 may predict a time to launch the virtual desktop session for the user based on the received data. As described above, the virtual desktop session may be executed on virtual machine (e.g., one of VM 1-VM N) managed by a hypervisor (i.e., virtualization layer 116A-116N) executed on a server (i.e., host 114A-114N) in a data center (e.g., cloud computing infrastructure 112). Further, virtual machine (e.g., one of VM 1-VM N) may be assigned to the user and accessed via remote network connection 132.

In an example, advisory module 108 analyzes the data related to the login pattern by applying a machine learning model to the data related to the login pattern of the user. For example, advisory module 108 analyzes the data related to the login pattern (e.g., stored in database 110) selected from a group consisting of historical user login data, administrator-specified rules for assigning the virtual desktop session at a defined time, and lightweight directory access protocol (LDAP)/active directory log scrapping and location services. Further, advisory module 108 may predict the time to launch the virtual desktop session for the user based on the analysis of the data. For example, advisory module 108 may analyze the data using machine learning techniques to determine which specific user should have VM assigned to him. For example, the advisory service may analyse the historical patterns of user logins learned from collecting usage data (e.g., time, location, and the like) related to user login times across the organization in order to determine that a VM should be assigned for a specific user at a particular time. In an example, a pre-launch time for launching the virtual desktop session may be set at a predefined time before the predicted time. For example, the pre-launch time may be set 30 minutes before the predicted time of the user launching time.

Furthermore, advisory module 108 may fetch, via network 132, security policy 120 from cloud-based endpoint protection platform 118 prior to the predicted time. In an example, security policy 120 includes rapid configuration rules, an application control policy to allow or deny an execution of a selected application, a user specific access control and network policy, or any combination thereof. Rapid configuration rules may describe how to enable and configure sets of rules that can be used to accomplish tasks such as application optimization, operating system and application hardening, and approval of files delivered by software distribution systems.

Further, advisory module 108 may populate a virtual machine (e.g., one of available virtual machines VM 1 to VM N) with security policy 120 before the user logs into the virtual desktop session. Further, advisory module 108 may create the virtual desktop session using virtual machine (e.g., one of VM 1 to VM N) populated with security policy 120 in response to a determination that the user logged into the virtual desktop session prior to an expiration of a timer. When client device 122 is accessing a remote desktop using a remote desktop protocol (e.g., RDP, PCoIP, VNC, etc.), the graphical user interface (GUI) of the desktop is generated on corresponding host (e.g., 114A-114N), the GUI image data is then encoded and transmitted over network 132 to client device 122, where it is decoded and displayed to the user.

Furthermore, advisory module 108 may discard fetched security policy 120 from virtual machine (e.g., one of VM 1 to VM N) in response to a determination that the timer expires without the user logged in to the virtual desktop session. In another example, advisory module 108 may predict a location of the user corresponding to the predicted time to launch the virtual desktop session based on analyzing the received data. Further, advisory module 108 may select a data center at a particular location to provision the virtual machine with the security policy based on the predicted time and predicted location. For example, location is one of the factors to be considered when selecting the data center. An increased distance between an organization and the data center may impact a network speed. Therefore, the virtual machine can be provisioned in the selected data center that can enhance the network speed. Similarly, various other factors such as reliability, security, network services capacity, emergency backup, and the like can be considered to select the data center.

Thus, advisory module 108 can intake and analyse data from a number of different sources, such as usage history, administrator specified rules, LDAP/Active directory log scrapping and location services, and the like. Once advisory module 108 predicts a time and location for user to login, advisory module 108 begins to pre-fetch rules and policies (i.e., security policy 120) for that user from cloud-based endpoint protection platform 118 and also associate purge timer. If user does not login prior to expiration of purge timer, pre-fetched policy 120 is purged. If the login event is detected prior to expiration of the purge timer, the purge time is cancelled and pre-fetched policies and rules 120 are used to create the virtual desktop session for the user. Hence, pre-fetching security policy 120 before the user logins to the VDI based on analytic data may reduce load on cloud-based endpoint protection platform 118 and increasing efficacy and scalability.

In some examples, the functionalities described in FIG. 1, in relation to instructions to implement functions of advisory module 108 and any additional instructions described herein in relation to the storage medium, may be implemented as engines or modules including any combination of hardware and programming to implement the functionalities of the modules or engines described herein. The functions of advisory module 108 may also be implemented by a processor. In examples described herein, the processor may include, for example, one processor or multiple processors included in a single device or distributed across multiple devices.

Further, the virtual desktop environment illustrated in FIG. 1 is shown purely for purposes of illustration and is not intended to be in any way inclusive or limiting to the embodiments that are described herein. For example, a typical enterprise VDI deployment would include many more host servers, which may be distributed over multiple data centers, which might include many other types of devices, such as switches, power supplies, cooling systems, environmental controls, and the like, which are not illustrated herein. Similarly, a single host server would host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the idea.

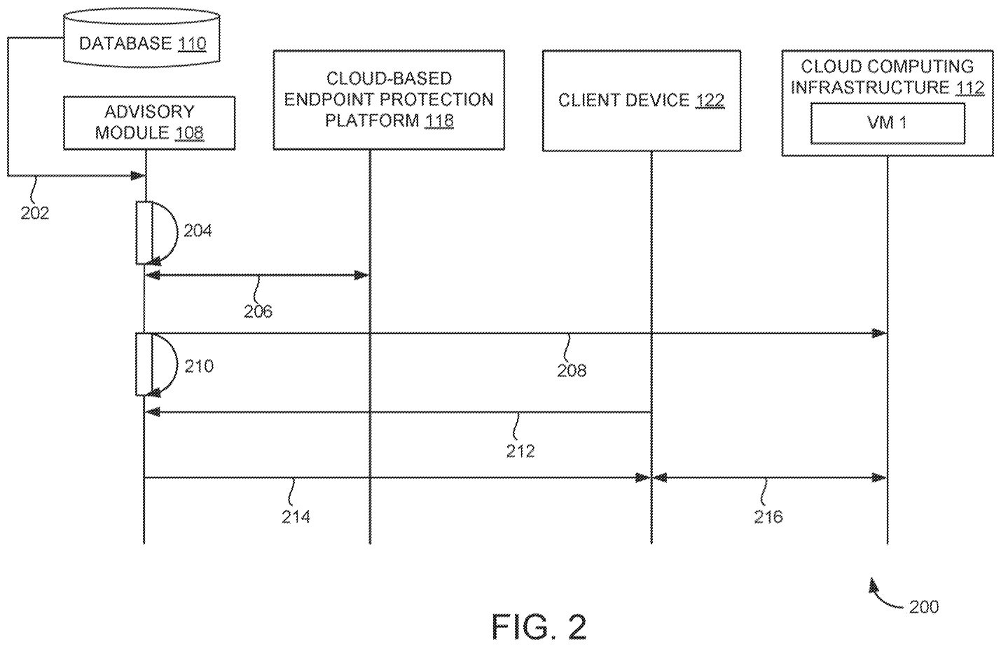

FIG. 2 is a sequence diagram 200 illustrating a sequence of events to populate a virtual machine (e.g., VM 1) with a security policy based on a pre-launch time to launch the virtual desktop session. For example, similarly named elements of FIG. 2 may be similar in structure and/or function to elements described with respect to FIG. 1. Sequence diagram 200 may represent the interactions and the operations involved in populating VM 1 with the security policy. FIG. 2 illustrates a process object including advisory module 108 and other entities such as cloud-based endpoint protection platform 118 (e.g., which stores the security policy), client device 122, and cloud computing infrastructure 112 (e.g., including the virtual machine) along with their respective vertical lines originating from them. The vertical lines of advisory module 108, cloud-based endpoint protection platform 118, client device 122, and cloud computing infrastructure 112 may represent the processes that may exist simultaneously. The horizontal arrows (e.g., 202, 206, 208, 212, 214, and 216) may represent the data flow steps between the vertical lines originating from their respective objects. Further, activation boxes (e.g., 204 and 210) between the horizontal arrows may represent the process that is being performed in the respective process object.

At 202, data related to a login pattern of a user over a period of time may be received by advisory module 108 from database 110. At 204, a time (i.e., a pre-launch time) to launch a virtual desktop session for the user may be predicted by advisory module 108 based on the received data.

At 206, the security policy may be fetched from cloud-based endpoint protection platform 118. At 208, the virtual machine VM 1 from a pool of available virtual machines may be assigned to the user and the virtual machine may be populated with the security policy. At 210, a timer defining a timeout period upon populating the virtual machine may be initiated.

At 212, a login request to a virtual desktop session may be received from the user via client device 122 prior to an expiration of the timer. At 214, the virtual desktop session may be created using the virtual machine populated with the security policy in response to a determination that the user logged into the virtual desktop session prior to an expiration of the timer. Further at 216, the user may access the virtual desktop session using VM 1.

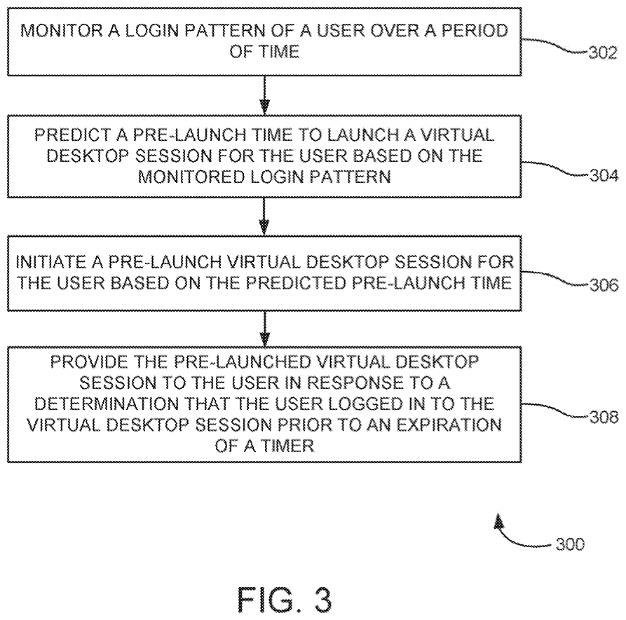

FIG. 3 is a flow diagram 300, illustrating an example computer-implemented method for providing a virtual desktop session. The process depicted in FIG. 3 represents generalized illustrations, and other processes may be added, or existing processes may be removed, modified, or rearranged without departing from the scope and spirit of the present application. In addition, the process may represent instructions stored on a computer-readable storage medium that, when executed, may cause a processor to respond, to perform actions, to change states, and/or to make decisions. Alternatively, the process may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but rather the flow chart illustrates functional information to design/fabricate circuits, generate computer-readable instructions, or use a combination of hardware and computer-readable instructions to perform the illustrated processes.

At 302, a login pattern of a user may be monitored over a period of time. In an example, monitoring the login pattern of the user includes monitoring the login pattern of the user by applying a machine learning model to data related to the login pattern of the user. For example, monitoring the login pattern of the user includes analyzing data selected from a group consisting of historical user login data, administrator-specified rules for assigning the virtual desktop session at a defined time, and lightweight directory access protocol (LDAP)/active directory log scrapping and location services. Further, the login pattern of the user may be monitored based on the analysis of the data, for instance, by applying the machine learning model.

At 304, a pre-launch time to launch a virtual desktop session for the user may be predicted based on the monitored login pattern. In an example, the virtual desktop session is executed on a virtual machine managed by a hypervisor executed on a server in the data center. The virtual machine may be assigned to the user and accessed via a client device.

At 306, a pre-launch virtual desktop session for the user may be initiated based on the predicted pre-launch time. In an example, initiating the pre-launch virtual desktop session includes fetching, via a network, a security policy from a cloud-based endpoint protection platform prior to the predicted pre-launch time and populating a virtual machine with the fetched security policy. In an example, fetching the security policy from the cloud-based endpoint protection platform includes fetching the security policy from the cloud-based endpoint protection platform before the user logs into the virtual desktop session using the pre-launch time. An example security policy includes rapid configuration rules, an application control policy to allow or deny an execution of a selected application, a user specific access control and network policy, or any combination thereof.

In an example, a location of the user likely to login to the virtual desktop session may be predicted based on the login pattern. Further, the data center may be selected based on the predicted location of the user. Furthermore, the virtual machine in the selected data center may be populated with the fetched security policy based on the pre-launch time.

At 308, the pre-launched virtual desktop session may be provided to the user in response to a determination that the user logged into the virtual desktop session prior to an expiration of a timer. In an example, the pre-launched virtual desktop session remains in an active state. Whenever the user logs in to the virtual desktop session, since the pre-launched initiated session is in active state, the user may be authenticated and the virtual desktop session may be provided to the user instantly without any delay.

Further, the fetched security policy may be discarded from the virtual machine in response to a determination that the timer expires without the user logged into the virtual desktop session. In this example, the pre-launched virtual desktop session may be disconnected when the user login is delayed for a pre-defined time after the pre-launch time.

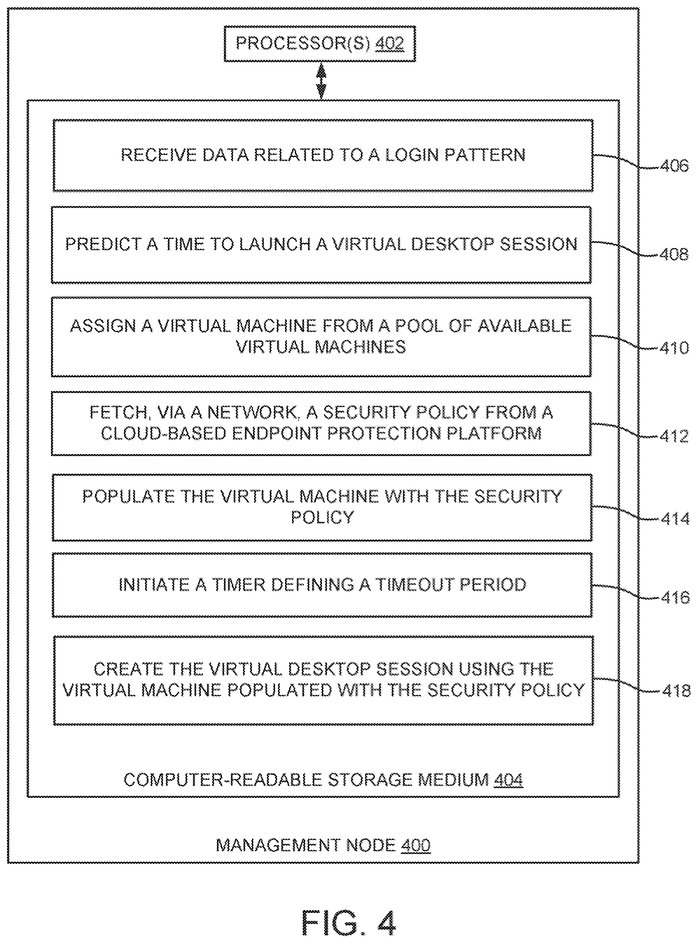

FIG. 4 is a block diagram of an example management node 400 including non-transitory computer-readable storage medium 404 storing instructions to create a virtual desktop session prior to a user logs into the virtual desktop session. Management node 400 may include a processor 402 and computer-readable storage medium 404 communicatively coupled through a system bus. Processor 402 may be any type of central processing unit (CPU), microprocessor, or processing logic that interprets and executes computer-readable instructions stored in computer-readable storage medium 404. Computer-readable storage medium 404 may be a random-access memory (RAM) or another type of dynamic storage device that may store information and computer-readable instructions that may be executed by processor 402. For example, computer-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 404 may be a non-transitory computer-readable medium. In an example, computer-readable storage medium 404 may be remote but accessible to management node 400.

Computer-readable storage medium 404 may store instructions 406, 408, 410, 412, 414, 416, and 418. Instructions 406 may be executed by processor 402 to receive data related to a login pattern of a user over a period of time. Instructions 408 may be executed by processor 402 to predict a time to launch a virtual desktop session for the user based on the received data. In an example, instructions to predict the time to launch the virtual desktop session include instructions to:
analyze the data related to the login pattern by applying a machine learning model or a pattern matching, and
predict the time to launch the virtual desktop session for the user based on the analysis of the data.

Instructions 410 may be executed by processor 402 to assign a virtual machine from a pool of available virtual machines to the user prior to the predicted time. Further, instructions 412 may be executed by processor 402 to fetch, via a network, a security policy from a cloud-based endpoint protection platform. Furthermore, instructions 414 may be executed by processor 402 to populate the virtual machine with the security policy.

In an example, computer-readable storage medium 404 may store instructions to:
predict a location of the user corresponding to the predicted time to launch the virtual desktop session, and
select a data center in a particular location to provision the virtual machine with the security policy based on the predicted time and predicted location.

Instructions 416 may be executed by processor 402 to initiate a timer defining a timeout period upon populating the virtual machine. Instructions 418 may be executed by processor 402 to create the virtual desktop session using the virtual machine populated with the security policy in response to a determination that the user logged into the virtual desktop session prior to an expiration of the timer. In an example, instructions to create the virtual desktop session include instructions to execute the virtual desktop session on the virtual machine managed by a hypervisor executed on a server in a data center. The virtual machine may be accessed via a remote network connection.

Further, computer-readable storage medium 404 may store instructions to:
discard the fetched security policy from the virtual machine in response to a determination that the timer expires without the user logged into the virtual desktop session, and
place the virtual machine back in the pool of available virtual machines.

Some or all of the system components and/or data structures may also be stored as contents (e.g., as executable or other computer-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A management node comprising:
a processor; and
a memory communicatively coupled to the processor, wherein the memory comprises an advisory module to:
receive data related to a login pattern of a user over a period of time;
predict a time to launch a virtual desktop session for the user based on the received data;
fetch, via a network, a security policy from a cloud-based endpoint protection platform prior to the predicted time;
populate a virtual machine with the security policy before the user logs into the virtual desktop session; and
create the virtual desktop session using the virtual machine populated with the security policy in response to a determination that the user logged into the virtual desktop session prior to an expiration of a timer.

2. The management node of claim 1, wherein the advisory module is to:
discard the fetched security policy from the virtual machine in response to a determination that the timer expires without the user logged into the virtual desktop session.

3. The management node of claim 1, wherein the advisory module is to:
analyze the data related to the login pattern selected from a group consisting of historical user login data, administrator-specified rules for assigning the virtual desktop session at a defined time, and lightweight directory access protocol (LDAP)/active directory log scrapping and location services; and
predict the time to launch the virtual desktop session for the user based on the analysis of the data.

4. The management node of claim 1, wherein the advisory module is to:
analyze the data related to the login pattern by applying a machine learning model to the data related to the login pattern of the user.

5. The management node of claim 1, wherein the virtual desktop session is executed on the virtual machine managed by a hypervisor executed on a server in a data center, wherein the virtual machine is assigned to the user and accessed via a remote network connection.

6. The management node of claim 1, wherein the security policy comprises rapid configuration rules, an application control policy to allow or deny an execution of a selected application, a user specific access control and network policy, or any combination thereof.

7. The management node of claim 1, wherein the advisory module is to:
predict a location of the user corresponding to the predicted time to launch the virtual desktop session; and
select a location of a data center to provision the virtual machine with the security policy based on the predicted time and predicted location.

8. A method for providing a virtual desktop session, comprising:
monitoring a login pattern of a user over a period of time;
predicting a pre-launch time to launch the virtual desktop session for the user based on the monitored login pattern;
initiating a pre-launch virtual desktop session for the user based on the predicted pre-launch time, wherein initiating the pre-launch virtual desktop session comprises:
fetching, via a network, a security policy from a cloud-based endpoint protection platform prior to the predicted pre-launch time; and
populating a virtual machine with the fetched security policy; and
providing the pre-launched virtual desktop session to the user in response to a determination that the user logged into the virtual desktop session prior to an expiration of a timer.

9. The method of claim 8, further comprising:
discard the fetched security policy from the virtual machine in response to a determination that the timer expires without the user logged into the virtual desktop session.

10. The method of claim 8, wherein fetching the security policy from the cloud-based endpoint protection platform comprises:
fetching the security policy from the cloud-based endpoint protection platform before the user logs into the virtual desktop session using the pre-launch time.

11. The method of claim 8, wherein monitoring the login pattern of the user comprises:
monitoring the login pattern of the user by applying a machine learning model to data related to the login pattern of the user.

12. The method of claim 8, wherein monitoring the login pattern of the user comprises:
analyzing data selected from a group consisting of historical user login data, administrator-specified rules for assigning the virtual desktop session at a defined time, and lightweight directory access protocol (LDAP)/active directory log scrapping and location services; and
monitoring the login pattern of the user based on the analysis of the data.

13. The method of claim 8, wherein the virtual desktop session is executed on a virtual machine managed by a hypervisor executed on a server in a data center, wherein the virtual machine is assigned to the user and accessed via a client device.

14. The method of claim 8, wherein the security policy comprises rapid configuration rules, an application control policy to allow or deny an execution of a selected application, a user specific access control and network policy, or any combination thereof.

15. The method of claim 8, further comprising:
predicting a location of the user likely to login to the virtual desktop session based on the login pattern;
selecting the data center based on the predicted location of the user; and
populating the virtual machine in the selected data center with the fetched security policy based on the pre-launch time.

16. A non-transitory computer readable storage medium comprising instructions that, when executed by a processor of a management node, cause the processor to:
receive data related to a login pattern of a user over a period of time;
predict a time to launch a virtual desktop session for the user based on the received data;
prior to the predicted time:
assign a virtual machine from a pool of available virtual machines to the user;
fetch, via a network, a security policy from a cloud-based endpoint protection platform;
populate the virtual machine with the security policy; and
initiate a timer defining a timeout period upon populating the virtual machine; and
create the virtual desktop session using the virtual machine populated with the security policy in response to a determination that the user logged into the virtual desktop session prior to an expiration of the timer.

17. The non-transitory computer readable storage medium of claim 16, further comprising instructions to:
discard the fetched security policy from the virtual machine in response to a determination that the timer expires without the user logged into the virtual desktop session; and
place the virtual machine back in the pool of available virtual machines.

18. The non-transitory computer readable storage medium of claim 16, wherein instructions to predict the time to launch the virtual desktop session comprise instructions to:
analyze the data related to the login pattern by applying a machine learning model or a pattern matching; and
predict the time to launch the virtual desktop session for the user based on the analysis of the data.

19. The non-transitory computer readable storage medium of claim 16, wherein instructions to create the virtual desktop session comprise instructions to:
execute the virtual desktop session on the virtual machine managed by a hypervisor executed on a server in a data center, wherein the virtual machine is accessed via a remote network connection.

20. The non-transitory computer readable storage medium of claim 16, further comprising instructions to:
predict a location of the user corresponding to the predicted time to launch the virtual desktop session; and
select a data center in a particular location to provision the virtual machine with the security policy based on the predicted time and predicted location.
